(19) United States
(12) Patent Application Publication
(10) Pub. No.: US 2022/0373991 A1
(43) Pub. Date: Nov. 24, 2022

(54) SELF-TESTING AUTOMATION SYSTEM

(71) Applicant: Endress+Hauser Process Solutions AG, Reinach (CH)

(72) Inventors: Michael Kuhl, Haldenwang (DE); Damian Schlager, Bad Bellingen (DE); Claudia Nowak, Freiburg (DE); Eric Birgel, Schopfheim (DE); Johannes Sprenger, Lörrach (DE); Mirko Brcic, Rheinfelden (CH)

(21) Appl. No.: 17/753,939

(22) PCT Filed: Aug. 20, 2020
(86) PCT No.: PCT/EP2020/073406

§ 371 Date: Mar. 18, 2022

(30) Foreign Application Priority Data
Sep. 18, 2019 (DE) 10 2019 125 120.6

(51) Int. Cl. G05B 19/406

(52) U.S. Cl. CPC G05B 19/406; G05B 2219/31368

(57) ABSTRACT

A self-testing automation system includes a decentralized distributed ledger-type database comprising a plurality of subscriber nodes, wherein the subscriber nodes exchange data with one another per transaction, and the database stores the transactions in data blocks which are linked together; a regulating mechanism which is implemented into each of the subscriber nodes, said regulating mechanism comprising information on the number and identity of all of the subscriber nodes as well as rules relating to actions, properties, and states of each of the subscriber nodes; and a plurality of automation components which are subscriber nodes of the decentralized database. Each of the subscriber nodes is designed to test or validate transactions between the subscriber nodes at all times using the regulating mechanism, and each of the subscriber nodes is designed to carry out at least one measure if a violation of the regulating mechanism is detected.

The invention relates to an automation technology system.

Field devices that are used in industrial plants are already known from the prior art. Field devices are often used in process automation engineering, as well as in manufacturing automation engineering. In principle, all devices that are used in a process-oriented manner and supply or process process-relevant data or information are referred to as field devices. Field devices are thus used for detecting and/or influencing process variables. Measuring devices, or sensors, are used for detecting process variables. These are used, for example, for pressure and temperature measurement, conductivity measurement, flow measurement, pH measurement, fill-level measurement, etc., and detect the corresponding process variables of pressure, temperature, conductivity, pH value, fill-level, flow, etc. Actuators are used for influencing process variables. These are, for example, pumps or valves that can influence the flow of a fluid in a pipe or the fill-level in a tank. In addition to the aforementioned measuring devices and actuators, field devices are also understood to include remote I/O's, radio adapters, or, generally, devices that are arranged at the field level.

A multitude of such field devices is produced and marketed by the Endress+Hauser group.

In modern industrial plants, field devices are usually connected to superordinate units via communications networks such as fieldbuses (Profibus®, Foundation® Fieldbus, HART®, etc.). Normally, the superordinate units are control units, such as an SPC (stored program control) or a DCS (distributed control system). The superordinate units are used for process control as well as for commissioning the field devices, among other things. The measured values detected by the field devices, especially by sensors, are transmitted via the respective bus system to one (or possibly several) superordinate unit(s) that further process the measured values, as appropriate, and relay them to the control station of the plant. The control station serves for process visualization, process monitoring, and process control, as well as diagnosis and data storage, etc., via the superordinate units. In addition, data transmission from the superordinate unit via the bus system to the field devices is also required, especially for configuration and parameterization of field devices and for controlling actuators. More and more, such fieldbuses of Ethernet-based communications networks are replaced.

Field devices create a variety of different data. These data, in addition to already mentioned measurement data of sensors, by means of which a plant operator receives information about the current process values of the measuring points of the plant, are, for example, control data, e.g., for controlling an actuator. Furthermore, the data comprise diagnostic, historical, and/or status data, which inform the plant operator of problems with field devices or the current status of the individual field devices, or calibration/parameterization data.

Current anomaly-detection systems in networked automation technology systems which are composed of several subscribers (for example, the OT world of a process environment, i.e., field devices, control units, etc.) are based upon historical data and recognize normal or abnormal behavior of the systems to be monitored by means of pattern recognition, e.g., by means of the use of AI (“artificial intelligence”) algorithms. Normal and abnormal behavior in such a networked system is determined over the entire state space of the properties of the subscribers, their relationships, e.g., the number of connections of a network subscriber or the services to be used, and the network properties. Such properties are, for example, the transferred data volume, the number or duration of a (network) connection, published services of a network subscriber, etc.

The large variance of the state space over the number and the non-standardization of the properties lead to a large, non-transparent amount of false positive messages. The system therefore loses its primary function, as a result of which a lack of confidence, especially of the transmitted process variables, arises, thus placing high demands upon the operator.

The measures in response to anomalies that occurred or were recognized are these days mostly reactive. This means that there is no gain for the operator. The entities to be checked do not currently have the possibility of addressing individual properties of all subscribers. Moreover, there is no reliable option for preventing the disconnection capability of the entities to be checked or to change/shut off individual checking functions during ongoing operation. Current anomaly systems are managed centrally, thereby increasing the risk of the “single point of failure.” The central management does not allow the subscribers to dynamically define/negotiate their properties and relationships. Anomalies can also, in general, not be prevented, but only reacted to afterwards.

The aim of the present invention is therefore to provide reliable, proactive, and safety-oriented anomaly detection in an automation technology system.

The aim is achieved by an automation technology system, comprising:
a decentralized, distributed database according to the distributed-ledger technology, especially a blockchain, comprising a plurality of subscriber nodes, wherein the subscriber nodes are designed to exchange data, or Information, with one another per transaction, wherein the database is designed to store the transactions, especially in data blocks linked to each other;
a rule set implemented on each of the subscriber nodes, wherein the rule set comprises information about the number and identity of all subscriber nodes, as well as rules relating to actions, properties, and states of each of the subscriber nodes;
a plurality of automation components, which are subscriber nodes of the decentralized database,
wherein each of the subscriber nodes is designed to check or validate transactions between the subscriber nodes at all times based upon the rule set, and wherein each of the subscriber nodes is designed to carry out at least one measure when a violation of the rule set is detected.

The advantage of the system according to the invention lies in a reliable detection of anomalies which occur within the database. Anomalies relate to malfunctions of the individual subscriber nodes, but also to changes in the behavior of the subscriber nodes, caused by attacks on subscriber nodes by unauthorized persons. The database is a distributed-ledger database. At least some of the subscriber nodes of the database are formed by automation components. These are components which are used in automation technology and serve to gather, relay, and process data which originate from a process-engineering process and/or are used to control this process. Accordingly, the automation components are field devices as defined at the outset, but also units arranged remotely such as cloud platforms, or IT components such as network switches. The subscriber nodes are in contact with one another by means of the Internet or the use of non-Internet-based telecommunications techniques (for example, via satellite). It can be provided that the automation components also be connected to an additional network—for example, a fieldbus. However, the data must then be transmitted synchronously via both networks (Internet and fieldbus) in order to be able to reliably detect anomalies.

By implementing the rule set in each subscriber node, the system can be operated autonomously, since each subscriber node checks a violation of the rule set. A central unit which is used to detect the anomalies is no longer required. The system has high reliability, also due to redundancies. The rule set is dynamically negotiated a priori by each individual subscriber node. As a result, the state space is drastically minimized so that fewer “false positive” anomalies are detected, and a fast, deterministic, reactive security system is created, which comprises permanently visible rules that are transparent for each subscriber node.

By using a distributed-ledger database, the system is transparent, decentralized, and self-managing. Since all data are stored by each subscriber node at all times, detected violations of rules or abnormalities for each node cannot be disputed at any time.

According to a first variant of the system according to the invention, it is provided that the decentralized database exclusively comprise the automation components as subscriber nodes.

According to a second variant of the system according to the invention, it is provided that the decentralized database comprise further subscriber nodes, in addition to the automation components. The subscriber nodes can thus also be inserted into an existing database. The further subscriber nodes can, for example, be IT components such as servers, etc., which do not have to be located in the vicinity of the plant.

According to an advantageous embodiment of the system according to the invention, it is provided that the rule set be stored as program code on each of the subscriber nodes, the program code being executed by the subscriber nodes. Within the scope of blockchain-based databases, such program codes are referred to as “smart contracts.” Smart contracts map, especially, contracts, or check or support the technical negotiation or handling of a contract, but can be expanded as desired, so that the rule set can be mapped.

According to an advantageous development of the system according to the invention, it is provided that the rule set include algorithms which, when executed on the subscriber nodes, carry out a check for an impending violation of the rule set.

According to an advantageous embodiment of the system according to the invention, it is provided that the algorithms comprise AI-based evaluations for checking an impending violation of the rule set. For example, algorithms which use neural networks or deep-learning-based algorithms are suitable. This makes it possible to steadily improve the rule set.

According to a preferred embodiment of the system according to the invention, it is provided that the results produced after an AI evaluation of a subscriber node be communicated to the algorithms of the further subscriber nodes. In this way, each of the subscriber nodes does not “learn” separately, but exchanges the findings so that the collectivity of subscriber nodes learns together, forms a store of experience, and continually improves the rule set.

According to an alternative advantageous embodiment of the system according to the invention, it is provided that the algorithms comprise threshold-based evaluations for checking an impending violation of the rule set. This alternative is suitable, especially, for subscriber nodes that have only limited resources available with regard to power, memory, and/or energy. In this regard, the learning aspect is in fact eliminated. However, new findings can be introduced by installing a new version of the rule set.

According to an advantageous embodiment of the system according to the invention, it is provided that the rule set have different types of algorithms, wherein the subscriber nodes are designed to select and execute at least one of the algorithms as a function of their respectively available resources. For example, certain powerful subscriber nodes can use AI-based algorithms and improve the rule set, while other, less powerful, subscriber nodes use threshold-based algorithms.

According to a preferred embodiment of the system according to the invention, it is provided that the rule set have a dynamic component and a static component, wherein the content of the static component cannot be changed, and wherein the content of the dynamic component can be changed and/or expanded.

According to an advantageous embodiment, it is provided that the system according to the invention be designed in such a way that the content of the dynamic component is changed and/or expanded in the event of an agreement of a predetermined portion of the subscriber nodes. For example, a permitted value range for a field device as a subscriber node is to be changed. This change in the rule set is proposed by the field device as a subscriber node, or, for example, by an operating PC of the user, which is also a subscriber node. During the change, it is checked, especially by all subscriber nodes, whether the change relates to a permissible category and/or whether the subscriber node which proposes the change can be authenticated. Only when, for example, more than half of the subscriber nodes can confirm this is the dynamic component of the rule set changed accordingly.

According to an advantageous embodiment of the system according to the invention, it is provided that the rule set comprise the following rules:
services by means of which the subscriber nodes are allowed to communicate in each case with other subscriber nodes according to the rule set;
a permitted value range in which measured values contained in the transactions of the subscriber nodes are provided;
a maximum packet rate and bandwidth of a respective subscriber node;
a maximum number of simultaneous connections of a subscriber node;
a maximum ratio of time and new connections of a subscriber node;
a maximum time for existing connections from or to a subscriber node;
error rate for connections between subscriber nodes;
resource usage of a subscriber node;
measurement and control value behavior
automation communications patterns (e.g., behavior of the acyclical and cyclical communications of the real-time bus)
parameter settings
data and communications heuristics or patterns
meta-communications data;
interface usage of a subscriber node.

According to an advantageous embodiment of the system according to the invention, it is provided that each of the subscriber nodes be designed to carry out at least one of the following measures upon detection of a violation of the rule set:
generating and outputting an alarm message;
blocking the communications within the database with an affected subscriber node;
stopping the communications outside the database with an affected subscriber node;
generating and outputting an analysis report about the detected violation of the rule set;
closing ports;
stopping the services of each subscriber node.

The invention is explained in greater detail with reference to the following figures. The following are shown:

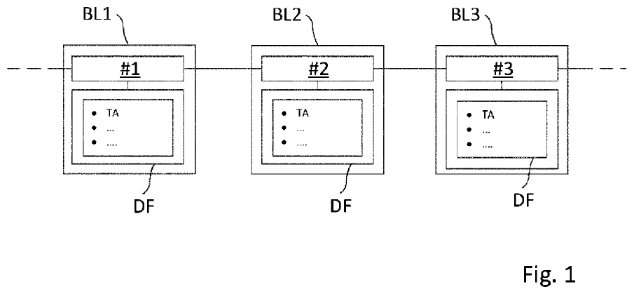

FIG. 1: an explanation of a database designed according to the distributed-ledger technology; and

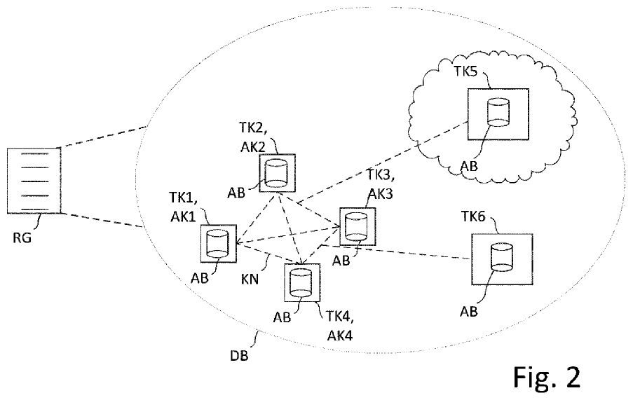

FIG. 2: a first exemplary embodiment of the system according to the invention.

FIG. 1 shows an explanation of a decentralized database DB designed according to a distributed-ledger technology. In the present case, the database DB is based upon blockchain technology. Blockchain technology has become known as the backbone of the “Bitcoin” Internet currency. A blockchain, i.e., a chain of linked data blocks BL1, BL2, BL3, allows a high degree of data integrity. The mode of operation of a database DB which is used for the invention is briefly explained below.

As a rule, a given data block BL1, BL2, BL3 is made up of at least two components: On the one hand, this is a data field DF. Data in the form of transactions TA are stored in this data field DF. The transaction TA refers to a transmission of the data from a first subscriber node TK1, TK2, . . . , TK6 to a second subscriber node TK1, TK2, . . . , TK6 in a communications network—for example, the Internet. A transaction TA contains a transmitted value, e.g., data of the field device FG, and the transmitter and the receiver of the transaction TA. Subscriber nodes TK1, TK2, . . . , TK6 are all devices which form the database or are connected thereto and allow the distributed-ledger functionality.

A data field DF of a data block BL1, BL2, BL3 contains at least one transaction TA, and, more often, multiple transactions TA.

On the other hand, a data block BL1, BL2, BL3 contains a checksum #1, #2, #3. Such a checksum #1, #2, #3 is a hash value and is created by sometimes complex calculations. For this purpose, all transactions TA of the data field of a block BL1, BL2, BL3 are calculated to an intermediate value. For example, the Merkle root of the total number of transactions TA is calculated for this. The exact functional principle is not addressed here. For this purpose, reference is made to https://en.wikipedia.org/wiki/Merkle_tree.

This calculated intermediate value is then converted with the checksum #1, #2, #3 of the previous data block BL1, BL2, BL3 to the checksum #1, #2, #3 of the current data block BL1, BL2, BL3. For example, the data block BL2 shown in FIG. 1 contains a checksum #2. This checksum #2 was thus calculated from the transactions TA stored in the data field DF of the data block B2 and the checksum #1 of the preceding data block BL1. Analogously, the data block BL3 shown in FIG. 1 contains a checksum #3. This checksum #3 was thus calculated from the transactions TA stored in the data field DF of the data block B3 and the checksum #2 of the preceding data block BL2.

The integrity of the data, i.e., the protection of the data from subsequent manipulation, is thus ensured by storing the checksum #1, #2, #3 of the preceding data block BL1, BL2 in the respective following data block BL2, BL3. A blockchain is thus made up of a series of data blocks BL1, BL2, BL3, in each of which one or more transactions TA are combined and provided with the checksum #1, #2, #3. A modification of data produces a modified intermediate value, thereby also modifying the checksum #1, #2, #3 of the respective data block BL1, BL2, BL3. The subsequent data block BL1, BL2, BL3 thus no longer matches the preceding data block BL1, BL2, BL3. In doing so, data of a once successfully validated data block BL1, BL2, BL3 can no longer be changed by an attacker.

New data blocks BL1, BL2, BL3 are created at regular intervals. All transactions TA which were created after the point in time at which the last data block BL1, BL2, BL3 was created are stored in the data field of the new data block BL1, BL2, BL3.

The complexity of the block creation can be increased due to the fact that the established checksum #1, #2, #3 must have a predefined format. For example, it is specified that the checksum must be 24 characters long, wherein the first four characters must have the numerical value 0. For this purpose, in addition to the intermediate value of the transactions TA and the checksum of the previous data block, a numerical sequence to be determined, called a “nonce” and having a fixed length, is used for calculating the checksum #1, #2, #3 of the current data block BL1, BL2, BL3. The calculation of the new checksum #1, #2, #3 takes longer, because there are only a few nonces that lead to the calculation of a checksum #1, #2, #3 with the given criteria. Finding such a suitable nonce in this case causes the described additional time expenditure.

After the checksum #1, #2, #3 of a new data block BL1, BL2, BL3 has been created, the data block is transmitted to all subscriber nodes TK1, TK2, . . . , TK6. The validatable subscriber nodes TK1, TK2, TK3, TK4 then check the checksum #1, #2, #3 of the new data block BL1, BL2, BL3. Only after successful validation is the data block BL1, BL2, BL3 stored in all subscriber nodes TK. In particular, a successful validation of more than half of all validatable subscriber nodes TK1, TK2, TK3, TK4 is required for this purpose. An attacker would therefore, for introducing/creating a foreign, malicious data block BL1, BL2, BL3, have to manipulate or control a large number of validatable subscriber nodes TK1, TK2, TK3, TK4, to successfully validate the introduced data block BL1, BL2, BL3. As the number of validatable subscriber nodes TK1, TK2, TK3, TK4 increases, this must be regarded as an almost impossible undertaking.

The validation of a data block BL1, BL2, BL3 requires significantly less effort than the creation of the data block BL1, BL2, BL3. The checksum #1, #2, #3 is back-calculated, and the intermediate value of the transactions TA or the checksum #1, #2, #3 of the previous data block BL1, BL2, BL3 is recovered and compared to the actual intermediate value or to the actual checksum #1, #2, #3 of the previous data block BL1, BL2, BL3. If these values match, the data block BL1, BL2, BL3 is successfully validated.

The following describes how a self-monitoring system for an automation technology plant can be set up with the aid of such a database DB:

FIG. 2 schematically illustrates the system according to the invention. The database DB, which is constructed as described above, is essentially composed of six subscriber nodes TK1, TK2, TK3, TK4, TK5, TK6, which are designed as full nodes. Each of them stores an image AB of the content of the database DB, i.e., the chain of the data blocks DB1, DB2, DB3. The subscriber nodes TK1, TK2, TK3, TK4 are automation components—for example, field devices (subscriber nodes TK1, TK2, TK3). By executing distributed-ledger software or a software stack, these automation components can act as subscriber nodes, load the image of the content of the database DB, and write data to the database and verify transactions. However, it cannot verify transactions. Examples of such field devices are mentioned in the introductory part of the description. The field devices collect, for example, measured values of a process-engineering process and transmit them within the database—for example, to a control unit (subscriber nodes TK4).

The subscriber nodes TK5 and TK6 are IT components; in particular, in the case of the subscriber node TK5, it is a cloud server, and, in the case of the subscriber node TK6, it is an operating PC of a user. If these two subscriber nodes are introduced into the OT network of the plant or have process-relevant operating applications, they likewise fall under the definition of an automation component.

A rule set is integrated as program code on each of the subscriber nodes TK1, . . . . It contains information about the number and identity of all subscriber nodes TK1, . . . , TK6, as well as rules relating to actions, properties, and states of each of the subscriber nodes TK1, . . . , TK6, and, during execution, allows a subscriber node TK1, . . . , TK6 to check the transactions of the subscriber nodes according to the rule set RG, and thus allows anomalies to be recognized. In the sense of the blockchain technology used as a database in the present example, such a rule set can be implemented as a smart contract.

The violation of a rule set, or an anomaly resulting therefrom, can be detected by means of two different methods. Both are implemented by corresponding algorithms, which, depending upon the available resources of the subscriber nodes TK1, . . . , TK6, can be implemented thereon.

On the one hand, the algorithms enable threshold-based evaluations. In the process, contents of transactions of the subscriber nodes TK1, . . . , TK6 are compared to the data in the rule set RG. If they deviate from one another or deviate from one another by a certain value (threshold value), this represents an anomaly or a rule violation.

Alternatively, the algorithms provide AI-based evaluations for checking an impending violation of the rule set RG. For example, algorithms which use neural networks or deep-learning-based algorithms are suitable. The results of the algorithms obtained after an AI evaluation of a subscriber node TK1, . . . TK6 can be communicated to the further subscriber nodes TK1, . . . , TK6 in order to establish a store of experience.

Likewise, the rule set contains a catalog of measures, linked to detected anomalies, whereby actions for eliminating faults and/or actions for preventing further errors/attacks are initiated.

In the following, a first exemplary embodiment shall be described, in which it is determined on the basis of the rule set RG whether a violation of the rule set RG or an anomaly is present:

A new, unknown device attempts to join the database DB as a new subscriber node. However, joining the database is possible only if it is permitted in the rule set RG that a potential subscriber be provided with unique identification information, which is also defined as an authorized subscriber in the rule set RG.

Here, a distinction can be made between three different cases, which trigger different reactions of the subscriber nodes.

On the one hand, the request to join may be unplanned and unintentional. In this case, the requesting device has no authorization. Its identification information is therefore not listed in the rule set RG, such that it cannot authenticate or identify itself. The subscriber nodes TK1, . . . , TK6 receive the request for access as a transaction, check its content—in this case, the sender identification—and detect a rule violation (possible by way of a threshold-based evaluation and/or by AI algorithm). As the resulting measure associated with this rule violation, any contractually non-compliant communication or transaction within the database DB with this device is prevented (Layer 7 or Edge/Switch can block).

In a second case, the request to join is planned and intended. The new potential subscriber node of the database makes the request for access. The subscriber nodes TK1, . . . , TK6 receive the request for access as a transaction, and check its content—in this case, the sender identification—and that it is present in the rule set RG. The device thus has a valid authorization and can authenticate or identify itself. Subsequently, the device is included as a new subscriber node in the database DB.

In a second case, the request to join is unplanned, but desired. In this case as well, the requesting device has no authorization. Its identification information is therefore not listed in the rule set RG, such that it cannot authenticate or identify itself. The subscriber nodes TK1, . . . , TK6 receive the request for access as a transaction, check its content—in this case, the sender identification—and detect a rule violation. As a measure, however, the existing subscriber nodes TK1, . . . , TK6 agree to insert the new identification information of the requesting device into the rule set RG. This can take place by the existing subscriber nodes TK1, . . . , TK6 checking the identification of the device and its rule set to be introduced, or negotiating a new rule set, based upon the new information of the device and the previous information of the existing rule set RG. In both cases, the device is either accepted or discarded as a new subscriber node in a majority procedure, i.e., a voting process. In the event that the device is accepted as new subscriber node, it must likewise agree to the newly-negotiated rule set RG.

The device can also be added as a new subscriber node by presenting its identification information and agreeing to the previous rule set RG, without introducing new rules itself. The existing subscriber nodes TK1, . . . TK6 check the identification information and include the device as a new subscriber node after it is checked whether the existing rule set RG can be adhered to by the properties of the new subscriber node. The above-described majority procedure or the voting process can also be carried out for this purpose.

Finally, a further exemplary embodiment is described for the method according to the invention. The subscriber nodes TK1, TK2, TK3, as field devices, continually collect measured values of a process-engineering process and transmit them to the superordinate unit (subscriber node TK4). A value range within which the measured values are allowed to vary has been defined by calibration and official verification and stored in the rule set RG. The subscriber nodes TK1, . . . , TK6 check the measured values, contained in the transactions of the subscriber nodes TK1, TK2, TK3, according to the rule set RG. If the value range is exceeded or fallen short of, these generate a warning to the plant operator as a measure. The value range being exceeded or fallen short of can be detected by a threshold-based evaluation or by means of AI algorithms. In the event that a subscriber node TK1, . . . , TK6 uses AI algorithms, the latter can also predict the value range being foreseeably exceeded or fallen short of, even if this has not yet occurred (“predictive maintenance”).

### LIST OF REFERENCE SYMBOLS

AK1, . . . , AK4 Automation components
BL1, BL2, BL3 Data block
BO Dashboard
DB Decentralized database
EL Electronics unit
FG Field device
KN Communications network
KS Communications Interface
RG Rule set
TA Transaction
TK1, . . . , TK6 Subscriber nodes
#1, #2, #3 Hash values of the data blocks

1-13. (canceled)

14. An automation technology system, comprising:
a decentralized, distributed database according to the distributed-ledger technology, especially a blockchain, comprising a plurality of subscriber nodes, wherein the subscriber nodes are designed to exchange data, or information, with one another per transaction, wherein the database is designed to store the transactions, especially in data blocks linked to each other;
a rule set which is implemented on each of the subscriber nodes, wherein the rule set comprises information about the number and identity of all of the subscriber nodes, as well as rules relating to actions, properties, and states of each of the subscriber node; and
a plurality of automation components, which are subscriber nodes of the decentralized database,
wherein each of the subscriber nodes is designed to check or validate transactions between the subscriber nodes at all times based upon the rule set, and
wherein each of the subscriber nodes is designed to carry out at least one measure when a violation of the rule set is detected.

15. The system of claim 14, wherein the decentralized database comprises the automation components as subscriber nodes.

16. The system of claim 13, wherein the decentralized database comprises further subscriber nodes, in addition to the automation components.

17. The system of claim 14, according to at least one of the preceding claims, wherein the rule set is stored as program code on each of the subscriber nodes, the program code being executed by the subscriber nodes.

18. The system of claim 14, wherein the rule set includes algorithms which, when executed on the subscriber nodes, carry out a check of an impending violation of the rule set.

19. The system of claim 18, wherein the algorithms comprise AI-based evaluations for checking an impending violation of the rule set.

20. The system of claim 19, wherein the results obtained after an AI evaluation of a subscriber node are communicated to the algorithms of the further subscriber nodes.

21. The system of claim 18, wherein the algorithms comprise threshold-based evaluations for checking an impending violation of the rule set.

21. The system of claim 18, wherein the rule set has different types of algorithms, and
wherein the subscriber nodes are designed to select and execute at least one of the algorithms as a function of their respectively available resources.

22. The system of claim 14, wherein the rule set claim 14, wherein the rule set has a dynamic component and a static component, wherein the content of the static component is not changeable, and wherein the content of the dynamic component is changeable and/or expandable.

23. The system of claim 22 which is designed in such a way that the content of the dynamic component is changed and/or expanded in the event of an agreement of a predetermined portion of the subscriber nodes.

24. The system of claim 14, wherein the rule set comprises the following rules:
services by means of which the subscriber nodes are allowed to communicate in each case with other subscriber nodes according to the rule set;
a permitted value range in which measured values contained in the transactions of the subscriber nodes are provided;
a maximum packet rate and bandwidth of a respective subscriber node;
a maximum number of simultaneous connections of a subscriber node;
a maximum ratio of time and new connections of a subscriber node;
a maximum time for existing connections from or to a subscriber node;
error rate for connections between subscriber nodes;
resource usage of a subscriber node;
measurement and control value behavior
automation communications patterns
parameter settings
data and communications heuristics or patterns
meta-communications data;
interface usage of a subscriber node.

25. The system of claim 14, wherein each of the subscriber nodes is designed to carry out at least one of the following measures when a violation of the rule set is detected:
generating and outputting an alarm message;
blocking the communications within the database with an affected subscriber node;
stopping the communications outside the database with an affected subscriber node;
generating and outputting an analysis report about the detected violation of the rule set;
closing ports;
stopping the services of each subscriber node.
